(19) United States
(12) Patent Application Publication
(10) Pub. No.: US 2023/0119677 A1
(43) Pub. Date: Apr. 20, 2023

(54) PIXEL STRUCTURE, DISPLAY PANEL WITH A PIXEL STRUCTURE, AND DISPLAY DEVICE WITH A PIXEL STRUCTURE

(71) Applicant: SHENZHEN CHINA STAR OPTOELECTRONICS SEMICONDUCTOR DISPLAY TECHNOLOGY CO., LTD., Shenzhen (CN)

(72) Inventor: Lixia Li, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 17/050,428

(22) PCT Filed: Jun. 18, 2020
(86) PCT No.: PCT/CN2020/096724

§ 371 Date: Oct. 23, 2020

(30) Foreign Application Priority Data
May 14, 2020 (CN) 202010407380.6

(51) Int. Cl. G09G 3/36

(52) U.S. Cl. CPC G09G 3/3607; G09G 3/3614; G09G 2320/0626; G09G 2300/0443; G09G 2320/0247; G09G 3/2074

(57) ABSTRACT

The present invention provides a pixel structure. In sub-pixels of the same color group and polarity of each of the pixel units, polarities of data lines on left and right sides of half of the sub-pixels are positive and negative respectively, polarities of data lines on left and right sides of another half of the sub-pixels are negative and positive respectively. When the same pixel unit switches between display images of two frames, a brightness thereof is unchanged, which prevents low grayscale flickering occurring during switching between the display images of the two frames. The present invention also provides a display panel with the pixel structure and a display device with the pixel structure.

### FIELD OF INVENTION

The present invention relates to a field of display technologies, especially relates to a pixel structure, a display panel with the pixel structure and a display device with the pixel structure.

### BACKGROUND OF INVENTION

With development of large size liquid crystal display panels, users have increasing demands to screen resolution. LCD display panels with a 8K resolution or higher resolution become a trends inevitably.

The LCD display panel with a 8K resolution or high resolution usually employs a HG2D pixel structure. An LCD display panel of 8K or higher resolution having the pixel structure has a low grayscale flickering phenomenon occurring during switching of a display image between two frames due to a capacitor coupling effect exiting between sub-pixels of the pixel structure and data lines.

### SUMMARY OF INVENTION

### Technical Issue

The present invention provides a pixel structure, a display panel with the pixel structure and a display device with the pixel structure, to solve a technical issue that a low grayscale flickering phenomenon occurs on the conventional display panel and display device during a display image switching between two frames.

### Technical Solution

In a first aspect, the present invention provides a pixel structure comprising a plurality of pixel units, wherein each of the pixel units comprises a plurality of sub-pixels arranged in a horizontal direction, and the sub-pixels divided in three color groups, wherein the sub-pixels in the same color group are divided in two polarity groups, and numbers of the sub-pixels of two polarities are equal to each other; wherein in the sub-pixels of the same color group and the same polarity, polarities of data lines in left and right sides of half of the sub-pixels are positive and negative respectively, and polarities of the data lines in left and right sides of another half of the sub-pixels are negative and positive respectively, and wherein when a display image is switched from a current frame to a next frame, the polarity of each of the data lines varies oppositely.

In some embodiments, two of the data lines are disposed on left and right sides of each of the sub-pixels respectively and extend in a vertical direction, each of the sub-pixels is connected to a corresponding one of the data lines, and each of the data lines is configured to input a data signal to the sub-pixels connected correspondingly to the data line.

In some embodiments, numbers of the sub-pixels of the three color groups are equal to one another.

In some embodiments, in the sub-pixels, colors of adjacent three of the sub-pixels are different from one another.

In some embodiments, the pixel units are arranged in an array, and the pixel structure further comprises:

a plurality of scan lines extends in the horizontal direction;

wherein the pixel units in a same row correspond to a same one of the scan lines, the pixel units in different rows correspond to different ones of the scan lines, the sub-pixels in each of the pixel units are connected on the same one of the scan lines, and each of the scan lines is configured to input a scan signal into the sub-pixels corresponding to the scan line.

In some embodiments, the scan signals received by adjacent two of the rows of the scan lines are the same or different.

In some embodiments, the polarities of adjacent two of the sub-pixels in the same row are the same.

In some embodiments, the polarities of adjacent two of the sub-pixels in the same row are oppose.

In a second aspect, the present invention provides a display panel, the display panel comprises a pixel structure comprises a plurality of pixel units, each of the pixel units comprises a plurality of sub-pixels arranged in a horizontal direction, the sub-pixels are divided in three color groups, the sub-pixels in the same color group are divided in two polarity groups, and numbers of the sub-pixels of two polarities are equal to each other; wherein in the sub-pixels of the same color group and the same polarity, polarities of data lines in left and right sides of half of the sub-pixels are positive and negative respectively, and polarities of the data lines in left and right sides of another half of the sub-pixels are negative and positive respectively, and wherein when a display image is switched from a current frame to a next frame, the polarity of each of the data lines varies oppositely.

In some embodiments, two of the data lines are disposed on left and right sides of each of the sub-pixels respectively and extend in a vertical direction, each of the sub-pixels is connected to a corresponding one of the data lines, and each of the data lines is configured to input a data signal to the sub-pixels connected correspondingly to the data line.

In some embodiments, numbers of the sub-pixels of the three color groups are equal to one another.

In some embodiments, in the sub-pixels, colors of adjacent three of the sub-pixels are different from one another.

In some embodiments, the pixel units are arranged in an array, and the pixel structure further comprises:

a plurality of scan lines extends in the horizontal direction;

wherein the pixel units in a same row correspond to a same one of the scan lines, the pixel units in different rows correspond to different ones of the scan lines, the sub-pixels in each of the pixel units are connected on the same one of the scan lines, and each of the scan lines is configured to input a scan signal into the sub-pixels corresponding to the scan line.

In some embodiments, the scan signals received by adjacent two of the rows of the scan lines are the same or different.

In a third aspect, the present invention provides a display device, the display device comprises a display panel, the display panel comprises a pixel structure comprises a plurality of pixel units, each of the pixel units comprises a plurality of sub-pixels arranged in a horizontal direction, the sub-pixels are divided in three color groups, the sub-pixels in the same color group are divided in two polarity groups, and numbers of the sub-pixels of two polarities are equal to each other; wherein in the sub-pixels of the same color group and the same polarity, polarities of data lines in left and right sides of half of the sub-pixels are positive and negative respectively, and polarities of the data lines in left and right sides of another half of the sub-pixels are negative and positive respectively, and wherein when a display image is switched from a current frame to a next frame, the polarity of each of the data lines varies oppositely.

In some embodiments, two of the data lines are disposed on left and right sides of each of the sub-pixels respectively and extend in a vertical direction, each of the sub-pixels is connected to a corresponding one of the data lines, and each of the data lines is configured to input a data signal to the sub-pixels connected correspondingly to the data line.

In some embodiments, numbers of the sub-pixels of the three color groups are equal to one another.

In some embodiments, in the sub-pixels, colors of adjacent three of the sub-pixels are different from one another.

In some embodiments, the pixel units are arranged in an array, and the pixel structure further comprises:

a plurality of scan lines extends in the horizontal direction;

wherein the pixel units in a same row correspond to a same one of the scan lines, the pixel units in different rows correspond to different ones of the scan lines, the sub-pixels in each of the pixel units are connected on the same one of the scan lines, and each of the scan lines is configured to input a scan signal into the sub-pixels corresponding to the scan line.

In some embodiments, the scan signals received by adjacent two of the rows of the scan lines are the same or different.

### Advantages

The present invention provides the pixel structure, the display panel with the pixel structure, and the display device with the pixel structure. The pixel structure comprises a plurality of sub-pixels arranged in a horizontal direction. The sub-pixels are divided in the sub-pixels of three colors, the sub-pixels having of same color are divided in two polarity groups, and numbers of the sub-pixels of the two polarities are equal to each other. In the sub-pixels of the same color group and the same polarity, polarities of data lines in left and right sides of half of the sub-pixels are positive and negative respectively, and polarities of the data lines in left and right sides of another half of the sub-pixels are negative and positive respectively, and wherein when a display image is switched from a current frame to a next frame, the polarity of each of the data lines varies oppositely. For the pixel structure, because the sub-pixels of the same color group in the same pixel unit have the sub-pixels of the positive polarity that brighten equally, the sub-pixels of the positive polarity that darken equally, the sub-pixels of the negative polarity that brighten equally, and the sub-pixels of the negative polarity that darken equally, both in a display image of a current frame and a display image of a next frame, therefore the same pixel unit have a constant brightness when switching between the display images of two frames, which prevents a low grayscale flickering phenomenon during switching between the display images of the two frames. Thus, the display panel with the pixel structure and the display device with the display panel can prevent the low grayscale flickering phenomenon during switching between the display images of the two frames.

### DESCRIPTION OF DRAWINGS

FIG. 1 is a schematic view of a pixel unit in a pixel structure provided by an embodiment of the present invention.

FIG. 2 is a schematic view of brightness of blue sub-pixels of the pixel unit of FIG. 1 in a display image of a current frame.

FIG. 3 is a schematic view of brightness of the blue sub-pixels of FIG. 2 in a display image of a next frame.

FIG. 4 is a schematic view of a pixel structure provided by an embodiment of the present invention.

FIG. 5 is a specific schematic view of a first pixel structure provided by an embodiment of the present invention.

FIG. 6 is a specific schematic view of a second pixel structure provided by an embodiment of the present invention.

FIG. 7 is a specific schematic view of a third pixel structure provided by an embodiment of the present invention.

FIG. 8 is a specific schematic view of a fourth pixel structure provided by an embodiment of the present invention.

FIG. 9 is a specific schematic view of a fifth pixel structure provided by an embodiment of the present invention.

FIG. 10 is a specific schematic view of a sixth pixel structure provided by an embodiment of the present invention.

### DETAILED DESCRIPTION OF PREFERRED EMBODIMENTS

To make the objective, the technical solution, and the effect of the present invention clearer and more explicit, the present invention will be further described in detail below with reference to the accompanying drawings. It should be understood that the specific embodiments described here are only used to explain the present invention instead of being used to limit the present invention.

An embodiment of the present invention provides a pixel structure comprises: a plurality of pixel units, the pixel units can be arranged in an array. The embodiment of the present invention has no specific limitation to an arrangement thereof.

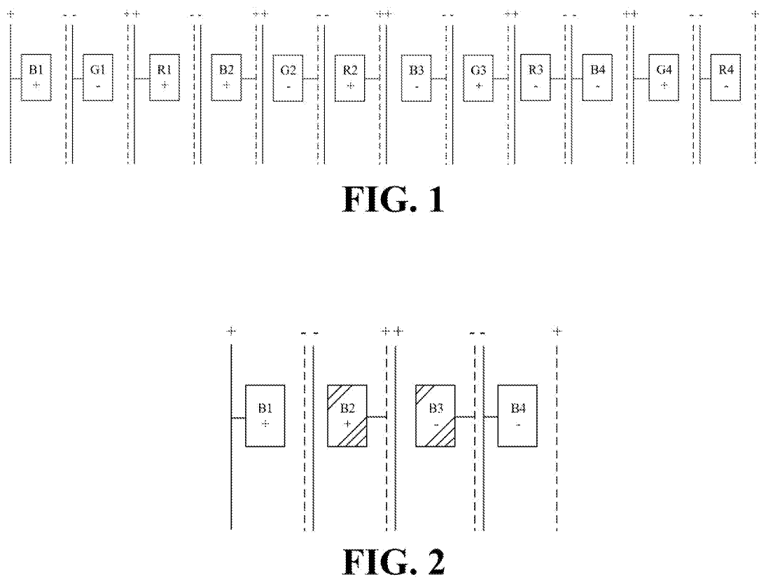

FIG. 1 is a schematic view of a pixel unit in a pixel structure provided by an embodiment of the present invention. To better understand FIG. 1, graphs and reference characters in FIG. 1 are described as follows. Rectangular frames refer to sub-pixels, R refers to red sub-pixels, G refers to green sub-pixels, B refers to blue sub-pixels. 1, 2, 3, 4 refer to serial numbers of the sub-pixels. “+” refers that a polarity of the sub-pixel is positive or a polarity of a data line is positive. “−” refers that a polarity of the sub-pixel is negative or a polarity of the data line is negative. Vertical solid lines refer to the data lines on a left side of the sub-pixels. Vertical broken lines refer to the data lines on a right side of the sub-pixels.

With reference to FIG. 1, each of the pixel units comprises a plurality of sub-pixels arranged in a horizontal direction. Two data lines are disposed on a left side and a right side of each of the sub-pixels respectively and extend along a vertical direction. A number of the data lines between adjacent two of the sub-pixels are two. Each of the sub-pixels is connected to the data line of one of the left side and the right side. Each of the data lines is configured to receive a data signal and input the data signal to corresponding ones of the sub-pixels. Each of the sub-pixels has a polarity the same as that of the data line connected thereto. It should be explained that the polarity of each of the sub-pixels the same to the polarity of the data line connected thereto refers that the polarity of each of the sub-pixels varies according to the variation of the polarity of the data line connected to the sub-pixel. When the polarity of each of the data lines is positive, the polarity of each of the sub-pixels is also positive. When the polarity of each of the data lines is negative, the polarity of each of the sub-pixels is also negative.

The sub-pixels in each of the pixel units can be divided in three color groups, the sub-pixels of the three color groups are red sub-pixels, green sub-pixels, and blue sub-pixels. Numbers of the red sub-pixels, green sub-pixels, and the blue sub-pixels are equal to one another or different from one another, and the embodiment of the present invention has no limit thereto.

When a display image of a current frame is displayed, the sub-pixels of the same color group are divided in two polarity groups, the sub-pixels of the two polarities are the sub-pixels of the positive polarity and the sub-pixels of the negative polarity respectively, and a number of the sub-pixels of the positive polarity is equal to a number of the sub-pixels of the negative polarity. Namely, the red sub-pixels can be divided in the sub-pixels of the positive polarity and the sub-pixels of the negative polarity equal in number, the green sub-pixels can be divided in the sub-pixels of the positive polarity and the sub-pixels of the negative polarity equal in number, and the blue sub-pixels can be divided in the sub-pixels of the positive polarity and the sub-pixels of the negative polarity equal in number.

In the sub-pixels of the same color group and the same polarity, polarities of data lines in left and right sides of half of the sub-pixels are positive and negative respectively, and polarities of the data lines in left and right sides of another half of the sub-pixels are negative and positive respectively. For example, with reference to FIG. 1, a number of the blue sub-pixels in each of the pixel units is four, the four blue sub-pixels are B1, B2, B3, and B4. B1 and B2 are the sub-pixels of the positive polarity, B3 and B4 are the sub-pixels of the negative polarity. The polarities of the data lines on the left and right sides of B1 are positive and negative respectively, the polarities of the data lines on the left and right sides of B2 are negative and positive respectively, the polarities of the data lines on the left and right sides of B3 are positive and negative respectively, and the polarities of the data lines on the left and right sides of B4 are negative and positive respectively.

FIG. 2 is a schematic view of brightness of blue sub-pixels of the pixel unit of FIG. 1 in a display image of a current frame. To better understand FIG. 2, graphs and reference characters in FIG. 2 are described as follows. Rectangular frames without oblique hatch filled inside refer to brightened sub-pixels, rectangular frames filled with an oblique hatch refer to darkened sub-pixels. It should be explained that brightening refers to a brightness greater than an ideal brightness, and darkening refers to a brightness less than the ideal brightness. The ideal brightness refers to the brightness of the sub-pixel when no capacitor coupling effect exists between the sub-pixel and the data line. Because the capacitor coupling effect exists in actual situations, each of the sub-pixels brightens or darkens. With reference to FIG. 2, when the display image switches from a previous frame to a current frame, because of a strong capacitor coupling effect of the data line on the rights side of each of the sub-pixels (in an embodiment of the present invention, it is assumed that a capacitor coupling effect of the data line on the right side of each of the sub-pixels is stronger), in the display image of the current frame, B1 of the positive polarity and B4 of the negative polarity are brightened, and B2 of the positive polarity and B3 of the negative polarity are darkened.

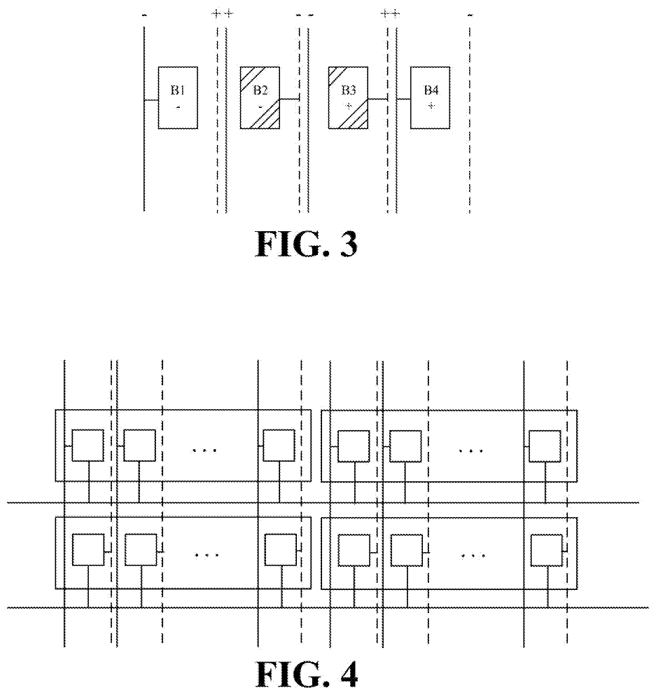

FIG. 3 is a schematic view of brightness of the blue sub-pixels of FIG. 2 in a display image of a next frame. To better understand FIG. 3, graphs and reference characters in FIG. 3 are described as follows. Rectangular frames without oblique hatch filled inside refer to brightened sub-pixels, rectangular frames filled with an oblique hatch refer to darkened sub-pixels. It should be explained that brightening refers to a brightness greater than an ideal brightness, and darkening refers to a brightness less than the ideal brightness. The ideal brightness refers to the brightness of the sub-pixel when no capacitor coupling effect exists between the sub-pixel and the data line. Because the capacitor coupling effect exists in actual situations, each of the sub-pixels brightens or darkens. With reference to FIG. 3, when a display image switches from a current frame to a next frame, the polarity of each of the data lines varies oppositely. In other words, the polarity of the data lines in a display image of a current frame, which is positive, is converted into negative in a display image of a next frame, and the polarity of the data lines in a display image of a current frame, which is negative, is converted into positive in a display image of a next frame. Because the polarity of each of the data lines is opposite another, in a display image of a next frame, B1 of the positive polarity is converted to B1 of the negative polarity, B2 of the positive polarity is converted to B2 of the negative polarity, B3 of the negative polarity is converted to B3 of the positive polarity, B4 of the negative polarity is converted to B4 of the positive polarity. Because of a strong capacitor coupling effect of the data line on the rights side of each of the sub-pixels (in an embodiment of the present invention, it is assumed that a capacitor coupling effect of the data line on the right side of each of the sub-pixels is stronger), B1 of the negative polarity and B4 of the positive polarity are brightened, and B2 of the negative polarity and B3 of the positive polarity are darkened.

It should be explained that a brightness a of the brightened sub-pixels of the positive polarity, a brightness b of the darkened sub-pixels of the positive polarity, a brightness c of the brightened sub-pixels of the negative polarity, and a brightness d of the darkened sub-pixels of the negative polarity are different from one another.

When a display image of a current frame is displayed, the brightness of the brightened B1 of the positive polarity is a, the brightness of the darkened B2 of the positive polarity is b, the brightness of the darkened of B3 of the negative polarity is d, and the brightness of the brightened B4 of the negative polarity is c. At this time, a sum of brightness of the blue sub-pixels is a+b+c+d when the display image of the current frame is displayed.

When a display image of a next frame is displayed, a brightness of the brightened B1 of the negative polarity is c, a brightness of the darkened B2 of the negative polarity is d, a brightness of the darkened B3 of the positive polarity is b, a brightness of the brightened B4 of the positive polarity is a. At this time, a sum of brightness of the blue sub-pixels is a+b+c+d when the display image of the next frame is displayed. Namely, when the display image switches from a current frame to a next frame, the brightness of the blue sub-pixels in the pixel units keeps unchanged. For the same reason, when the display image switches from the current frame to the next frame, the brightness of the red sub-pixels in the pixel units keeps unchanged, and the brightness of the green sub-pixels also has no changes.

The present invention provides the pixel structure, the display panel with the pixel structure, and the display device with the pixel structure. The pixel structure comprises a plurality of sub-pixels arranged in a horizontal direction. The sub-pixels are divided in the sub-pixels of three colors, the sub-pixels having of same color are divided in two polarity groups, and numbers of the sub-pixels of the two polarities are equal to each other. In the sub-pixels of the same color group and the same polarity, polarities of data lines in left and right sides of half of the sub-pixels are positive and negative respectively, and polarities of the data lines in left and right sides of another half of the sub-pixels are negative and positive respectively, and wherein when a display image is switched from a current frame to a next frame, the polarity of each of the data lines varies oppositely. For the pixel structure, because the sub-pixels of the same color group in the same pixel unit have the sub-pixels of the positive polarity that brighten equally, the sub-pixels of the positive polarity that darken equally, the sub-pixels of the negative polarity that brighten equally, and the sub-pixels of the negative polarity that darken equally, both in a display image of a current frame and a display image of a next frame, therefore the same pixel unit have a constant brightness when switching between the display images of two frames, which prevents a low grayscale flickering phenomenon during switching between the display images of the two frames.

In some embodiments, with reference to FIG. 1, for a pixel unit, two data lines are disposed on a left side and a right side of each of the sub-pixels of each of the pixel units in a vertical direction respectively. In other words, each of the sub-pixels corresponds to two data lines, and such two data lines are located on the left and right sides of the corresponding one of the sub-pixels respectively. Each of the sub-pixels is connected to a corresponding one of the data lines. In other words, each of the sub-pixels is only connected to the corresponding data line on the left side, or is only connected to the corresponding data line on the right side.

It should be explained that when the sub-pixel is connected to the corresponding data line on the left side, the polarity of the sub-pixel is the same as the polarity of the data line on the left side. When the sub-pixel is connected to the corresponding data line on the right side, the polarity of the sub-pixel is the same as the polarity of the data line on the right side.

In some embodiments, for one pixel unit, numbers of the sub-pixels of the three color groups in the pixel unit are equal to one another. In other words, in one pixel unit, the number of the red sub-pixels, the number of the green sub-pixels, and the number of the blue sub-pixels are equal.

In some embodiments, for a pixel unit, adjacent three of the sub-pixels in the pixel unit have different colors. For example, in a pixel unit, the sub-pixels of three colors can be arranged at intervals in a sequence of red, green, and blue, and can also be arranged at intervals in a sequence of blue, green, and red, and the embodiment of the present invention has no limit thereto.

It should be explained that numbers of the sub-pixels of the three color groups in the pixel units in FIG. 1 are equal to one another, and the sub-pixels of the three color groups are arranged at intervals in a sequence of blue, green, and red.

FIG. 4 is a schematic view of a pixel structure provided by an embodiment of the present invention. To better understand FIG. 4., graphs and reference characters in FIG. 4 are described as follows. Large rectangular frames refer to pixel units, small rectangular frames refer to sub-pixels, vertical solid lines refers to data lines on a left side of the sub-pixels, vertical broken lines refer to data lines on a right side of the sub-pixels, and horizontal straight lines refer to scan lines. With reference to FIG. 4, pixel units in the pixel structure are arranged in an array, and the pixel structure further comprises:

a plurality of scan lines extends in the horizontal direction; wherein the pixel units in a same row correspond to a same one of the scan lines, the pixel units in different rows correspond to different ones of the scan lines, the sub-pixels in each of the pixel units are connected on the same one of the scan lines, and each of the scan lines is configured to input a scan signal into the sub-pixels corresponding to the scan line.

In some embodiments, scan signals received by adjacent two of the scan lines respectively are the same or different.

In some embodiments, polarities of adjacent two of the sub-pixels in the same column are same or opposites.

In some embodiments, pixel structure further comprises a source electrode driver, the source electrode driver is connected to the data lines and is configured to input a data signal into the data lines connected thereto.

In some embodiments, pixel structure further comprises: GOA units, each of the GOA unit are connected to the scan lines and is connected to a scan signal into the scan lines connected thereto. It should be explained that the GOA units to which adjacent two rows of the scan lines are connected are the same or different. If the GOA units connected to adjacent two rows of the scan lines are the same, the signals received by the two rows of the scan lines will be the same. If the GOA units connected to adjacent two rows of the scan lines are the different, the signals received by the two rows of the scan lines will be the different.

As a preferred embodiment, the present embodiment sets forth specific schematic views of various pixel structures fulfilling the arrangement rule of the sub-pixels of the above embodiment.

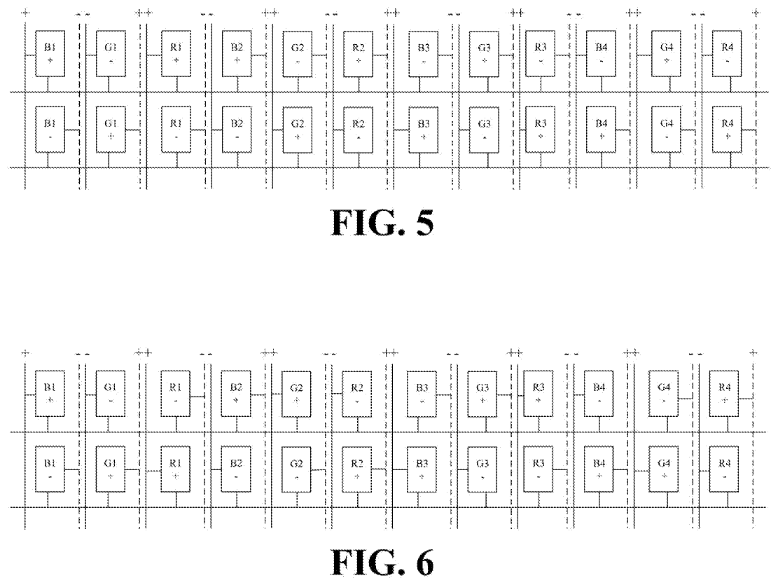

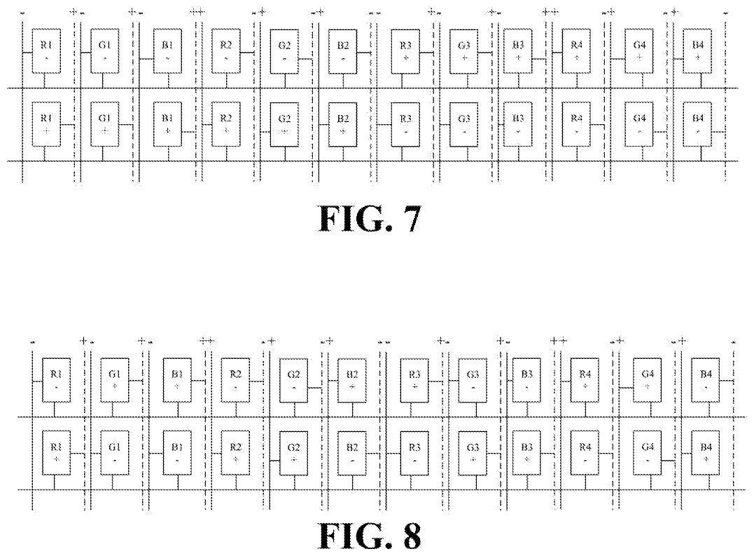

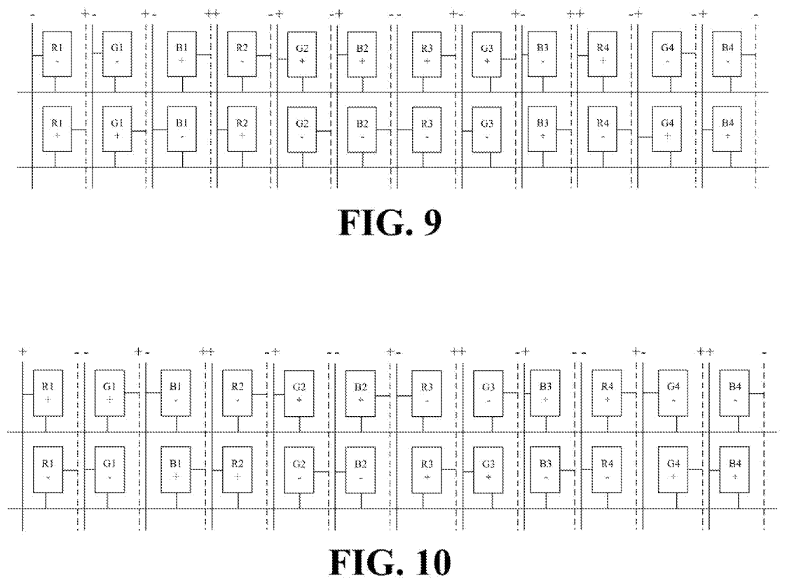

Specifically, FIG. 5 is a specific schematic view of a first pixel structure provided by an embodiment of the present invention. FIG. 6 is a specific schematic view of a second pixel structure provided by an embodiment of the present invention. FIG. 7 is a specific schematic view of a third pixel structure provided by an embodiment of the present invention. FIG. 8 is a specific schematic view of a fourth pixel structure provided by an embodiment of the present invention. FIG. 9 is a specific schematic view of a fifth pixel structure provided by an embodiment of the present invention. FIG. 10 is a specific schematic view of a sixth pixel structure provided by an embodiment of the present invention.

Each of the pixel structures in FIGS. 5 to 10 illustrates two pixel units, wherein twelve sub-pixels in each row constitute a pixel unit. A color and a polarity of each of the sub-pixels in each of the pixel units in each of the pixel structures, polarities of the data lines on the left and right sides of each of the sub-pixels, a connection relationship between each of the sub-pixels and the data lines have been illustrated in corresponding figures, and would not be described repeatedly. It should be explained that types of the pixel structures provided by the embodiment of the present invention are not limited to the above six ones, the embodiment of the present invention would not list them one by one.

The embodiment of the present invention also provides a display panel, comprising one of the pixel structures of the above embodiment.

Specifically, the pixel structure in the display panel provided by an embodiment of the present invention comprises a plurality of sub-pixels arranged in a horizontal direction. The sub-pixels are divided in the sub-pixels of three colors, the sub-pixels having of same color are divided in two polarity groups, and numbers of the sub-pixels of the two polarities are equal to each other. In the sub-pixels of the same color group and the same polarity, polarities of data lines in left and right sides of half of the sub-pixels are positive and negative respectively, and polarities of the data lines in left and right sides of another half of the sub-pixels are negative and positive respectively, and wherein when a display image is switched from a current frame to a next frame, the polarity of each of the data lines varies oppositely.

For the pixel structure, because the sub-pixels of the same color group in the same pixel unit have the sub-pixels of the positive polarity that brighten equally, the sub-pixels of the positive polarity that darken equally, the sub-pixels of the negative polarity that brighten equally, and the sub-pixels of the negative polarity that darken equally, both in a display image of a current frame and a display image of a next frame, therefore the same pixel unit have a constant brightness when switching between the display images of two frames, which prevents a low grayscale flickering phenomenon during switching between the display images of the two frames.

An embodiment of the present invention also provides a display device comprising the display panel of the above embodiment.

Specifically, the display device provided by an embodiment of the present invention comprises the display panel of the above embodiment, and the pixel structure of the display panel of the above embodiment comprises a plurality of sub-pixels arranged in a horizontal direction. The sub-pixels are divided in the sub-pixels of three colors, the sub-pixels having of same color are divided in two polarity groups, and numbers of the sub-pixels of the two polarities are equal to each other. In the sub-pixels of the same color group and the same polarity, polarities of data lines in left and right sides of half of the sub-pixels are positive and negative respectively, and polarities of the data lines in left and right sides of another half of the sub-pixels are negative and positive respectively, and wherein when a display image is switched from a current frame to a next frame, the polarity of each of the data lines varies oppositely.

For the pixel structure, because the sub-pixels of the same color group in the same pixel unit have the sub-pixels of the positive polarity that brighten equally, the sub-pixels of the positive polarity that darken equally, the sub-pixels of the negative polarity that brighten equally, and the sub-pixels of the negative polarity that darken equally, both in a display image of a current frame and a display image of a next frame, therefore the same pixel unit have a constant brightness when switching between the display images of two frames, which prevents a low grayscale flickering phenomenon during switching between the display images of the two frames. Thus, when the display panel with the pixel structure is applied to the display device, the display device can prevent the low grayscale flickering phenomenon during switching between the display images of the two frames.

It can be understood that for a person of ordinary skill in the art, equivalent replacements or changes can be made according to the technical solution of the present invention and its inventive concept, and all these changes or replacements should belong to the scope of protection of the appended claims of the present invention.

What is claimed is:

1. A pixel structure comprising a plurality of pixel units, wherein each of the pixel units comprises a plurality of sub-pixels arranged in a horizontal direction, and the sub-pixels divided in three color groups, wherein the sub-pixels in the same color group are divided in two polarity groups, and numbers of the sub-pixels of two polarities are equal to each other; wherein in the sub-pixels of the same color group and the same polarity, polarities of data lines in left and right sides of half of the sub-pixels are positive and negative respectively, and polarities of the data lines in left and right sides of another half of the sub-pixels are negative and positive respectively, and wherein when a display image is switched from a current frame to a next frame, the polarity of each of the data lines varies oppositely.

2. The pixel structure as claimed in claim 1, wherein two of the data lines are disposed on left and right sides of each of the sub-pixels respectively and extend in a vertical direction, each of the sub-pixels is connected to a corresponding one of the data lines, and each of the data lines is configured to input a data signal to the sub-pixels connected correspondingly to the data line.

3. The pixel structure as claimed in claim 2, wherein numbers of the sub-pixels of the three color groups are equal to one another.

4. The pixel structure as claimed in claim 3, wherein in the sub-pixels, colors of adjacent three of the sub-pixels are different from one another.

5. The pixel structure as claimed in claim 1, wherein the pixel units are arranged in an array, and the pixel structure further comprises:
a plurality of scan lines extends in the horizontal direction;
wherein the pixel units in a same row correspond to a same one of the scan lines, the pixel units in different rows correspond to different ones of the scan lines, the sub-pixels in each of the pixel units are connected on the same one of the scan lines, and each of the scan lines is configured to input a scan signal into the sub-pixels corresponding to the scan line.

6. The pixel structure as claimed in claim 5, wherein the scan signals received by adjacent two of the rows of the scan lines are the same or different.

7. The pixel structure as claimed in claim 5, wherein the polarities of adjacent two of the sub-pixels in the same row are the same.

8. The pixel structure as claimed in claim 5, wherein the polarities of adjacent two of the sub-pixels in the same row are oppose.

9. A display panel, wherein the display panel comprises a pixel structure comprises a plurality of pixel units, each of the pixel units comprises a plurality of sub-pixels arranged in a horizontal direction, the sub-pixels are divided in three color groups, the sub-pixels in the same color group are divided in two polarity groups, and numbers of the sub-pixels of two polarities are equal to each other; wherein in the sub-pixels of the same color group and the same polarity, polarities of data lines in left and right sides of half of the sub-pixels are positive and negative respectively, and polarities of the data lines in left and right sides of another half of the sub-pixels are negative and positive respectively, and wherein when a display image is switched from a current frame to a next frame, the polarity of each of the data lines varies oppositely.

10. The display panel as claimed in claim 9, wherein two of the data lines are disposed on left and right sides of each of the sub-pixels respectively and extend in a vertical direction, each of the sub-pixels is connected to a corresponding one of the data lines, and each of the data lines is configured to input a data signal to the sub-pixels connected correspondingly to the data line.

11. The display panel as claimed in claim 10, wherein numbers of the sub-pixels of the three color groups are equal to one another.

12. The display panel as claimed in claim 11, wherein in the sub-pixels, colors of adjacent three of the sub-pixels are different from one another.

13. The display panel as claimed in claim 9, wherein the pixel units are arranged in an array, and the pixel structure further comprises:
a plurality of scan lines extends in the horizontal direction;
wherein the pixel units in a same row correspond to a same one of the scan lines, the pixel units in different rows correspond to different ones of the scan lines, the sub-pixels in each of the pixel units are connected on the same one of the scan lines, and each of the scan lines is configured to input a scan signal into the sub-pixels corresponding to the scan line.

14. The display panel as claimed in claim 13, wherein the scan signals received by adjacent two of the rows of the scan lines are the same or different.

15. A display device, wherein the display device comprises a display panel, the display panel comprises a pixel structure comprises a plurality of pixel units, each of the pixel units comprises a plurality of sub-pixels arranged in a horizontal direction, the sub-pixels are divided in three color groups, the sub-pixels in the same color group are divided in two polarity groups, and numbers of the sub-pixels of two polarities are equal to each other; wherein in the sub-pixels of the same color group and the same polarity, polarities of data lines in left and right sides of half of the sub-pixels are positive and negative respectively, and polarities of the data lines in left and right sides of another half of the sub-pixels are negative and positive respectively, and wherein when a display image is switched from a current frame to a next frame, the polarity of each of the data lines varies oppositely.

16. The display device as claimed in claim 15, wherein two of the data lines are disposed on left and right sides of each of the sub-pixels respectively and extend in a vertical direction, each of the sub-pixels is connected to a corresponding one of the data lines, and each of the data lines is configured to input a data signal to the sub-pixels connected correspondingly to the data line.

17. The display device as claimed in claim 16, wherein numbers of the sub-pixels of the three color groups are equal to one another.

18. The display device as claimed in claim 17, wherein in the sub-pixels, colors of adjacent three of the sub-pixels are different from one another.

19. The display device as claimed in claim 15, wherein the pixel units are arranged in an array, and the pixel structure further comprises:
a plurality of scan lines extends in the horizontal direction;
wherein the pixel units in a same row correspond to a same one of the scan lines, the pixel units in different rows correspond to different ones of the scan lines, the sub-pixels in each of the pixel units are connected on the same one of the scan lines, and each of the scan lines is configured to input a scan signal into the sub-pixels corresponding to the scan line.

20. The display device as claimed in claim 19, wherein the scan signals received by adjacent two of the rows of the scan lines are the same or different.
